(19) United States
(12) Patent Application Publication
(10) Pub. No.: US 2026/0221056 A1
(43) Pub. Date: Jul. 30, 2026

(54) LABEL, SYSTEM AND METHOD FOR APPLYING A LABEL TO A MULTI-PART CONTAINER

(71) Applicant: Schreiner Group GmbH & Co. KG, Oberschleissheim (DE)

(72) Inventors: Stefan KRAUSS, München (DE); Birgit RIEDMAIER, Gröbenzell (DE); Philipp OLIVER, Starnberg (DE)

(73) Assignee: Schreiner Group GmbH & Co. KG, Oberschleissheim (DE)

(21) Appl. No.: 19/148,796

(22) PCT Filed: Jan. 25, 2024
(86) PCT No.: PCT/EP2024/051691

§ 371 Date: Jul. 17, 2025

(30) Foreign Application Priority Data
Jan. 30, 2023 (DE) 10 2023 102 140.0

(51) Int. Cl. G09F 3/02; G09F 3/00

(52) U.S. Cl. CPC G09F 3/0288; G09F 3/0292; G09F 3/0297; G09F 2003/0245; G09F 2003/0251; G09F 2003/0272; G09F 2003/0277

(57) ABSTRACT

A label for a multi-part container has front and opposite rear label edges, and first and adjacent second label portions. The label portions extend along the front and rear label edges. The first label portion is designed to be attached to a container body, and the second label portion is designed to be attached to a container closure. The first label portion protrudes relative to the second label portion at the front label edge in relation to an application direction, so that when operationally applying the label to the container, the first label portion contacts the container before the second label portion, and so that when opening the container with the label applied, the label can be severed and at least part of the second label portion together with the container closure can be removed from the first label portion and the container body.

The present invention relates to a label for a multi-part container that can contribute to reliable identification and secure tamper protection for the container in a simple and cost-effective manner. The invention also relates to a system comprising such a label and a multi-part container. The invention further relates to a method for applying such a label to a multi-part container.

Labels are used, among other things, for authorization, authentication, or to prove the origin of an item to which they are affixed. For example, a labeling arrangement is used when it is necessary to protect ingredients against unauthorized access and to indicate that the associated container has been opened. This applies in particular to containers in the pharmaceutical and medical fields, whose contents are to be protected against tampering.

A task underlying the invention is to contribute to reliable and secure labeling for a multi-part container in a simple and cost-effective manner.

The task is solved by the features of the independent patent claims. Advantageous developments are specified in the respective dependent patent claims.

According to an aspect of the invention, a label for a multi-part container comprises a front label edge and an opposite rear label edge, as well as a first label portion and an adjacent second label portion. The label portions extend along the front and rear label edges, respectively, wherein the first label portion is designed to be attached to a container body of the container and the second label portion is designed to be attached to a container closure of the container. The first label portion protrudes from the front label edge relative to an application direction compared to the adjacent second label portion, so that when the label is applied to the container in the normal manner, the first label portion comes into contact with the container before the second label portion in terms of time and space. When the container with the label applied is opened, the label can be cut through and at least part of the second label portion can be removed together with the container closure from the first label portion and the container body.

The label structure described above enables pharmaceutical containers such as syringes, vials, or injection bottles to be labeled reliably and automatically, and provides particularly reliable and secure identification. Because the label has a protruding leading edge, the label structure ensures that the forces generated during labeling are not transferred to other parts of the container, or at least significantly reduced. This applies, for example, to torsional force transfers, which are particularly undesirable in the case of closure caps of sterile containers and entail the risk that established sterility is lost due to relative movements of the closure cap relative to the container body.

It is a finding in connection with the present invention that, in the case of pharmaceutical containers such as syringes, a tamper-evident feature is useful, so that, for example, a closure area and a container area are connected to each other by means of an adhesive label. It is desirable that a cap area remains as free as possible from mechanical stress during processing so as not to compromise the sterility of the closure area. In particular, relative movement between a container body and a closure cap or closure element should be avoided as far as possible.

If, for example, a conventional label with a straight or uniformly aligned front edge is attached to a syringe, the label may first come into contact with a syringe cap, causing torsional forces to act on it as the label is wrapped around the syringe. Accordingly, there is a risk that the syringe cap will rotate to a certain extent when the label is applied, thereby performing a relative movement in comparison to the syringe body until the label also comes into contact with the syringe body. This has a negative effect on labelability and can, in particular, jeopardize the established sterility of the syringe.

The label structure described enables mechanical coupling to a reference system and also prevents or at least minimizes undesirable force transmission to other parts of the container. When attaching the label, for example to a syringe, the label structure described first establishes contact with the syringe body and then with the syringe closure, which is implemented, for example, as a closure element and/or syringe cap. The label is therefore first fixed to the syringe body before the trailing part of the label encompasses the syringe cap. This prevents, among other things, torsion-induced movements between the syringe parts due to the attachment of the label to the syringe.

The label can be single-layer or multi-layer and is particularly suitable for automated application to containers that are designed in two or more parts, whereby one container part is rotatable or movable relative to another. This usually concerns closure elements which are twisted off and/or pulled off from the associated container body when the container is opened. Due to the label structure described, it is possible, for example, to dispense a large number of such labels at high speed by machine, whereby, for example, 300-400 syringes per minute can be labeled reliably and safely.

According to an embodiment of the label, the first and/or second label portions have an adhesive area and an adhesive-neutral area on a respective underside, so that the first and/or second label portions can be adhesively attached to the container at least in sections. The adhesive-neutral area makes it possible, for example, to remove the label from the container in sections in order to check the contents. The adhesive-neutral area can be designed so that no adhesive is applied to the respective area on the underside and/or so that an adhesive weakening agent is applied in a predetermined manner. The adhesive-neutral area can be designed so that it is not adhesive or has reduced adhesive properties compared to the adhesive area.

According to a further embodiment of the label, the first label portion has a siliconized area on the upper side of the front edge of the label, so that a predetermined adhesive weakening is provided. The label can be designed as a wrap-around or over-wrap label in order to cover as much of the surface of the container as possible, so that a reliable hold and/or the greatest possible additional protection for the contents of the container is provided. In the case of an over-wrap label, the label overlaps itself at least partially, so that, for example, an area at the rear edge of the label covers the siliconized area at the front edge of the label. If necessary, the label can be lifted again at the rear edge, as the siliconized area provides a predetermined weakened adhesive strength. The label may also have a tab at the rear edge of the label, the underside of which may also have a non-adhesive or reduced-adhesion area to make it easier to grip the tab.

In connection with this description, terms such as “top,” “bottom,” “front,” and “back” refer to positions and orientations as they would be when the label is used as intended. Thus, a top side faces an external area or away from the container and usually displays information such as printing and/or labeling. The bottom side is accordingly facing the container body. The front edge of the label refers to the side of the label that is first applied to the container in accordance with the direction of application. The rear edge of the label is accordingly the opposite side of the label, which is usually pressed on last when wrapping the syringe or container. Furthermore, the front and rear label edges are connected to each other by an upper and a lower label edge, which, for example, represent opposite label sides in a substantially rectangular design of the label.

Furthermore, the two label portions extend from left to right between the front and rear label edges and are arranged one above the other when viewed from above. The first label portion thus extends between the front, rear, and lower label edges and can accordingly also be referred to as the lower label portion, which is attached to the lower part of the container, which is realized by the container body. The container closure essentially forms a head portion of the container and is usually arranged at the top of the container body, so that the second label portion can also be referred to as the upper label portion. The second, trailing label portion extends between the front, rear, and upper label edges and may be directly adjacent to the lower label portion. Alternatively, a further intermediate portion of the label is provided between the upper trailing label portion and the lower leading label portion. Alternatively, with regard to a view from above of the label, one or more further label portions may be formed above and/or below the first and second label portions.

According to a further embodiment of the label, the first label portion is formed at the front label edge with a wave shape, crenellated shape, or zigzag shape. The front label edge may have various shapes that prove useful for the respective container to which the label is to be attached. The front edge of the label can be straight and designed to be attached parallel to a longitudinal axis of the container. The container is usually cylindrical and essentially rotationally symmetrical, so that the longitudinal axis as the central axis also represents a cylinder and/or rotation axis around which the containers are rotated when applying a respective label.

The first label portion may further have a protruding area at the front edge of the label, which comprises a graduation for a filling volume for a content of the container. The graduation forms, for example, a milliliter scale whose scale lines are oriented perpendicular to the longitudinal axis of the container when the label is affixed to the container as intended. The protruding area with or without graduation can be designed in particular as a siliconized area, as described above.

According to a further embodiment of the label, the front edge of the label is designed such that an angle with a value greater than 0° up to and including 180° is provided in a transition between the first and second label portions. For example, the front edge of the label runs predominantly straight and vertically when viewed from above, with the second label portion being slightly set back compared to the first, leading label portion. This creates a step in the transition area, so that there is essentially an angle of 90° between the upper edge of the first label portion, which is horizontal when viewed from above, and the subsequent vertical edge of the second label portion.

The first and second label portions have a deliberately set offset so that the subsequent second label portion begins, for example, 1-25 mm, preferably 5-20 mm, after the leading label edge of the first label portion. The second label portion is used in particular to secure a primary cap of the container and is designed so that it can establish sufficient adhesive force on the primary cap. Furthermore, any weakening area, for example in the form of a perforation between the first and second label portions, must be taken into account so that reliable adhesion of the label and opening or cutting in the weakening area is possible. Accordingly, an offset of the trailing second label portion is designed in particular to match the size of the container and the respective container parts.

The second label portion has, for example, a protruding area at the front edge of the label, which is spaced apart from the first label portion so that an angle of essentially 180° is formed in the transition between the first and second label portions at the front edge of the label. According to such a design, for example, a free space is provided between the protruding area of the upper, second label portion and the leading lower, first label portion. The free space may be provided, for example, to accommodate a container portion, such as a bead or an outwardly extending element, at a position between the container closure and the container body.

According to a further embodiment of the label, a slit is formed in a transition between the first and second label portions, so that the first and second label portions are separated in sections at the front label edge. In particular, the two label portions are formed directly adjacent to each other as neighboring areas of one or more common label layers and, according to the described embodiment, are partially separated, cut apart, or detached from each other. Thus, a certain degree of mobility of the two label portions relative to each other can be provided, which can have a beneficial effect on an application process.

The label can also be designed so that the first and/or second label portion comprises a respective label layer that provides a barrier function against the passage of a gas and/or a liquid, a protective function against UV radiation, and/or a predetermined temperature resistance. The label may accordingly comprise one or more functional layers that take into account a respective intended application of the label and may thus be designed as a single layer or multiple layers. The leading first label portion comprises at least one layer of the label composite that adheres to the container. Such a functional layer can provide a predetermined inhibition of light or electromagnetic radiation in a predetermined wavelength range, such as ultraviolet. The label may, for example, comprise a respective label layer which is designed as an at least partially transparent, white and/or colored film element. Alternatively or additionally, the first and/or second label portion may have an adhesive area with a dark or black adhesive and/or a dark or black reference layer on a respective underside.

The label can be designed as a wrap-around or over-wrap around label in order to provide the greatest possible protection for the contents of the container. For example, the label can be designed so that, when used on a syringe, it extends over the syringe shoulder and over the syringe cap, closing the resulting sleeve over the syringe cap and forming a closed loop. This also provides additional protection for the shoulder and closure area of the syringe or container in general against light/UV radiation and/or against the ingress of gas or water. Alternatively or additionally, the previously described and/or further functionalities, such as UV/light protection, a barrier protective film, and/or a intended cryogenic application of the label, can be taken into account so that corresponding functionalities can be integrated by selecting a suitable top material for a label layer or the label and/or by selecting a suitable adhesive. Depending on the intended application, it may also be beneficial to specifically select an adhesive that is suitable for cryogenic applications and autoclaving, for example, so that the label can be used in a particularly wide temperature range, from −196° C. for deep-freezing applications to +140° C. for sterilization applications.

The label can be designed in particular to comprise a preferably adhesive-neutral tear-off area with a tear-off element. Such a tear-off element can be designed as a tear strip and/or as a perforation arranged between the first and second label portions, so that when the container to which the label is applied is opened, the label can be severed along the perforation or tear strip in a predetermined manner and at least part of the second label portion can be easily removed together with the container closure from the first label portion and the container body.

The label thus enables secure sealing of, for example, primary packaging and containers in the pharmaceutical sector, thereby guaranteeing or indicating the integrity of a medicine package. This prevents the unintentional reuse of a correspondingly labeled primary packaging after use and clearly and reliably indicates that the primary packaging has been opened for the first time. The label thus also counteracts tampering with the primary packaging or indicates that it has been opened for the first time.

Furthermore, the label can include security features such as a void layer, which is arranged in the label layer or coupled with it, for example. The void layer can be arranged below the label layer and above an adhesive layer, for example, in relation to the stacking direction. The void layer provides a void effect that offers protection against tampering. For example, the void layer is implemented with two or more structures with different adhesive strengths or release gradations. For example, a more strongly adhesive structure in the form of lettering is implemented in the void structure, while other sections of the void structure are less adhesive.

If the void structure or the label with a void layer is applied to an object to be marked, when the label is removed, for example, the more strongly adhesive lettering remains stuck to the object, while the less strongly adhesive sections are removed with the label or a label portion detached from the object. Alternatively, the structures described can also be designed with the opposite adhesive strength, so that, for example, the structure in the form of lettering is less adhesive.

Alternatively or additionally, security features in the form of punched holes can be provided, which create a predetermined weakening structure in a layer of the label. This allows, for example, tear-off positions to be provided at which the label tears off in a predetermined manner in the event of an attempt at tampering or when the container to which it is applied is opened. Alternatively or additionally, further perforations may be provided in one or more layers of the label, which enable a specific layer to be cut through or separated.

The label may also have RFID functionality, for example, an RFID transponder may be arranged on the label or integrated into it. The RFID transponder comprises an RFID chip and an antenna structure that is signal-coupled to the RFID chip. Due to the label structure described and the leading first label portion, the antenna structure and tamper loops can also be protected from mechanical stress and premature faulty triggering in a transition area between the container body and the container closure. Alternatively or additionally, the label may also include functionality based on another radio standard, such as Bluetooth LE. Furthermore, active systems including power supply are also possible, which, for example, track or store temperature and/or time points.

Alternatively, the label may be designed so that the first and second label portions are not offset from each other. The label accordingly has, for example, a square or rectangular shape or overall contour, so that the first label portion does not protrude relative to the second label portion and does not form a front edge, or no trailing front edge of the second label portion is formed. However, the other features of such a label, which are described above or below, may also be provided for such an embodiment of the label.

According to a further aspect of the invention, a system comprises a design of the label described above, which is attached to a multi-part object or container. A surface or outer surface of the container thus forms a substrate for the label and can, for example, be realized by the outer surface of a syringe or an injection vial. The label is applied to the container in such a way that the first label portion of the label is attached to the container body and the second label portion of the label is attached to the container closure. Due to the leading front edge of the label in the area of the lower, second label portion, this portion comes into contact with the container or the container body first and, in relation to the direction of application, is also spatially arranged in front of the upper, second label portion on the container. Since the system comprises a design of the multifunctional label described, the properties and features of the multifunctional label are also disclosed for the system and vice versa.

According to a further aspect of the invention, a method for applying a label to a multi-part container comprises providing a container divisible into several parts with a container body and a container closure coupled to the container body. The method further comprises attaching the label to the container so that the first label portion comes into contact with the container and is attached to the container body, and subsequently the second label portion comes into contact with the container and is attached to the container closure, so that when the container with the label applied is opened, the label can be severed in a predetermined manner and at least part of the second label portion can be removed from the first label portion and the container body together with the container closure.

The method can be further configured, for example, in that the label is provided in such a way that the first label portion and/or the second label portion has an adhesive area and an adhesive-neutral area on a respective underside, so that the first and/or the second label portion can be adhesively attached to the container at least in sections, and that the first label portion has a siliconized area on the front label edge on an upper side, so that a predetermined adhesive weakening is provided. The method accordingly comprises wrapping the container with the label so that the label completely encloses a radial circumference of the container and the first label portion with the adhesive area comes to rest at least partially on the siliconized area.

Since the respective method is specifically designed for applying a design of the label described above, the properties and characteristics described in connection with the label are also disclosed for the application method and vice versa.

The label and the method make it possible to prevent tampering with the integrity of primary packaging materials in the cap area. This is made possible by the special label design, which ensures that when the label is applied, the leading edge is fixed to the container body before the trailing edge of the label covers the cap area. The label can be designed as a self-adhesive label and can be multi-layered or multi-layered so that information can be stored on one or more layers, with the leading first label portion comprising at least one of these layers. A siliconized surface can enable controlled opening and resealing or reattachment of the label to the container.

Furthermore, a graduation can be provided which is set up to indicate the filling volume or units of the contents of the container, for example in the case of an opaque film element, on an edge of the label, such as the front edge of the label. Alternatively, a graduation may also be formed in other label areas, for example in transparent label structures. Preferably, such a graduation is placed in a label part permanently connected to the primary packaging material in order to avoid higher tolerances that may arise during opening and closing.

The label may also be provided with a partial print on the upper side with silicone varnish or similar varnishes, on which adhesives can only develop low forces, in order to establish targeted control of the required opening forces. This can be formed, for example, in a label area which, when the label is applied to the container, is assigned to the transition area between the container closure and the container body.

Furthermore, an adhesive-neutralized tab may be provided, which allows the label to be partially opened or detached over the height of the contents to be inspected. Such a concept may be designed in such a way that a perforation in the label must first be cut through or is cut through by opening or lifting the label. The label may have one or more adhesive-neutralized areas that allow the label to be opened or lifted over the height of the contents to be inspected. A transition area from a non-adhesive area to an adhesive area limits the permissible degree of opening, for example, by causing the force required for opening to increase abruptly in the transition area.

The upper, second label portion, which is preferably adhered to the container closure, can remain at least partially on the container closure as a label area after the container has been opened. In addition to colors and coatings, such an area can also be equipped with electronic components, such as RFID functionality. Furthermore, components of electronic components, such as antenna structures or conductor tracks of the RFID functionality, can be designed in such a way that they extend into the second label portion on the container closure, so that they are altered or severed and specifically damaged by unscrewing the container closure. In addition to a visually visible proof of opening, an electronic proof of first opening can thus be provided.

When using transparent film elements, one or more viewing windows can also be integrated into the label layout, allowing the contents of the container and, if necessary, a graduation to be viewed to a limited extent even before the label is opened or removed from the container.

The label can be used in particular for applications where it is necessary to cover as much of the surface of the primary container as possible in order to achieve the desired effect, for example in light protection applications, protection against UV radiation, protection against reactive gases such as oxygen in relation to some medications, and/or where the entire structure shown is designed with a composite material that can create a barrier effect against the critical gases. The label may therefore feature, for example, EVOH-based (ethylene vinyl alcohol copolymer) material compositions, but also structures that form a barrier layer based on metal oxides, such as AlO_{X} (aluminum oxides). A film element can still have a transparent appearance or, if required, be designed to be opaque.

The described embodiments of the label ensure, due to the special label structure, that the label is only coupled to the development in relation to the reference system in the form of the container body and does not transfer any undesirable forces to the other parts of the container to be labeled.

The following section explains examples of the invention using schematic drawings. They show:

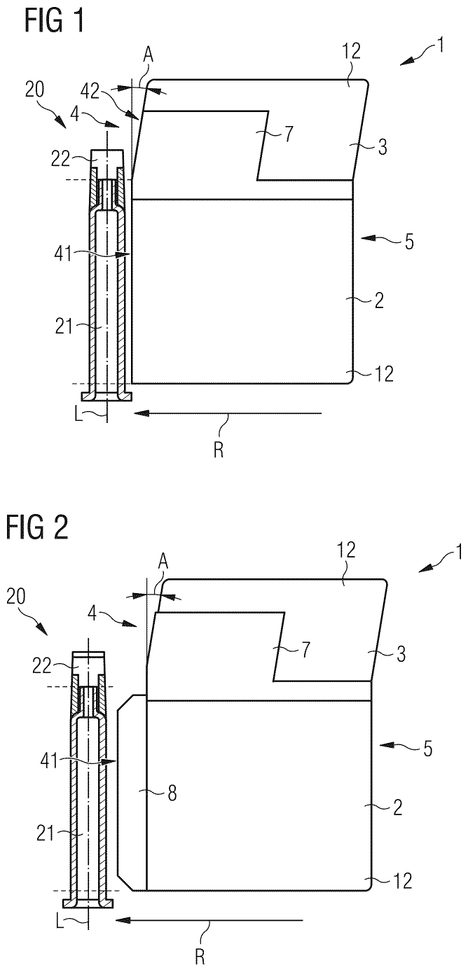

FIGS. 1-5 examples of a label for a multi-part container in a respective top view,

FIGS. 6-9 further embodiments of a label for a multi-part container in a respective top view in respective detailed views,

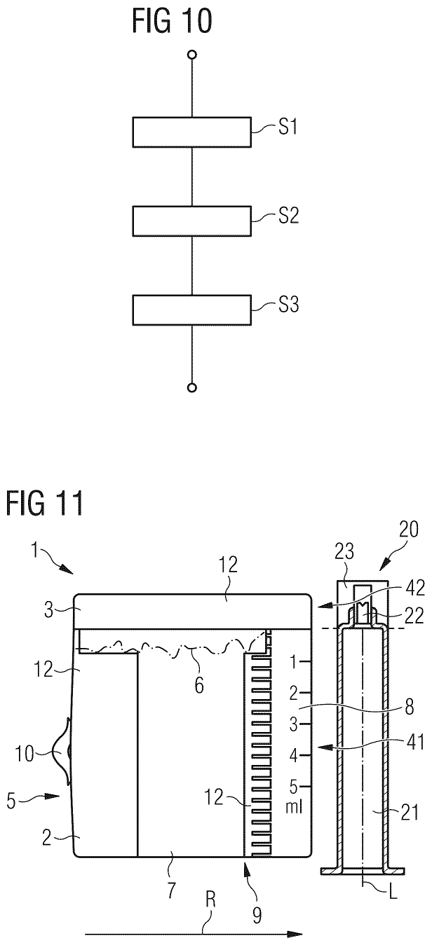

FIG. 10 a flow chart for a method of applying the label according to FIGS. 1-9 to a multi-part container, and

FIG. 11 another embodiment of a label for a multi-part container in a top view.

Elements or features of the same design or function are identified with the same reference numerals across all figures. For reasons of clarity, not all elements or features shown are identified with corresponding reference numerals in all figures, possibly.

FIGS. 1 to 5 show various embodiments of a label 1 for a multi-part container in the form of a syringe 20 in a respective top view. The label 1 has a front label edge 4 and an opposite rear label edge 5. Furthermore, the label 1 comprises a first label portion 2 and an adjacent second label portion 3, which extend along the front and rear label edges 4 and 5, respectively. The first label portion 2 is designed to be attached to a syringe body 21 of the syringe 20. The second label portion 3 is designed to be attached to a syringe cap of the syringe 20, which comprises a cap element 22 and/or a cap element 23, which is, for example, placed on the cap element 22 and partially or completely surrounds it.

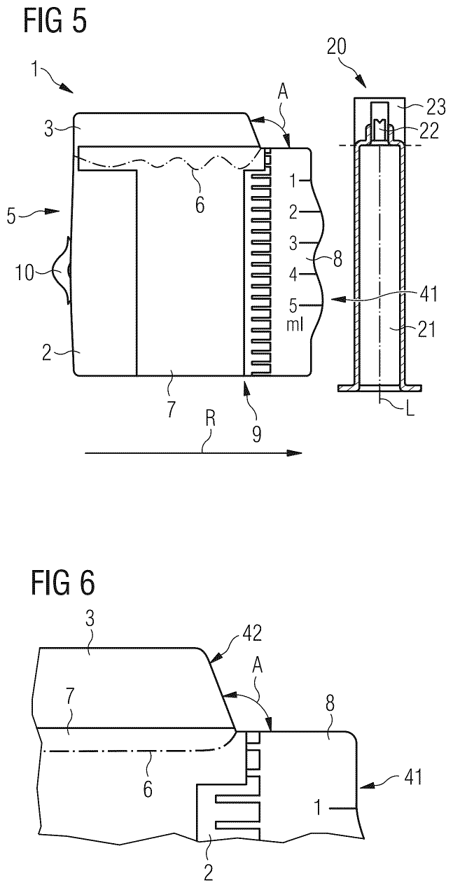

In FIGS. 4 and 5, the cap element 23 completely surrounds the closure element 22 and the second label portion 3 is attached only to the cap element 23. Alternatively, the cap element 23 may also only partially surround the closure element 22 in an upper region of the closure element 22. In such a case, the second label portion 3 is attached to the cap element 23 in the upper region of the syringe closure and to the closure element 22 in the lower region of the syringe closure. The second label portion 3 can be attached to the closure element 22 and/or to the cap element 23 completely up to the respective upper end or only partially, for example up to the respective center of the closure element 22 and/or cap element 23. In the event that the closure element 22 is a Luer closure, the second label portion 3 may also be attached only to the associated Luer thread.

The first label portion 2 protrudes from the front label edge 4 in relation to an application direction R compared to the second label portion 3, so that when the label 1 is applied to the syringe 20 in accordance with normal use, the first label portion 2 comes into contact with the syringe 20 before the second label portion 3, and so that when the syringe 20 with the label 1 applied is opened, the label 1 can be cut through and at least part of the second label portion 3 can be removed together with the syringe cap 22, 23 from the first label portion 2 and the syringe body 21.

The illustrations in FIGS. 1-5 each refer to a view from above of the top of label 1, which, when attached to syringe 20, faces an external area or is oriented away from the syringe body 21. Accordingly, a lower side of the label 1 is oriented such that, when attached to the syringe 20, it faces away from an external area or toward the syringe body 21. The front and rear label edges 4 and 5 refer to the application direction R, which faces the syringe 20. The leading front label edge 4 is thus closer to the syringe 20 than the trailing rear label edge 5 when the label 1 is applied to the syringe 20.

The label structure described above allows syringes 20 or alternative pharmaceutical containers, such as vials or injection bottles, to be labeled reliably and automatically, enabling particularly reliable and secure labeling. Due to the fact that the leading front label edge 4 protrudes in the area of the first label portion 2, the label structure ensures that forces occurring during labeling are not transferred to other parts of the syringe 20, or at least are significantly reduced. This applies, for example, to torsional force transmissions, which are particularly undesirable in the case of the syringe closure 22, 23 and entail the risk that the established sterility of the syringe 20 will be lost due to relative movements of the syringe closure 22, 23 relative to the syringe body 21.

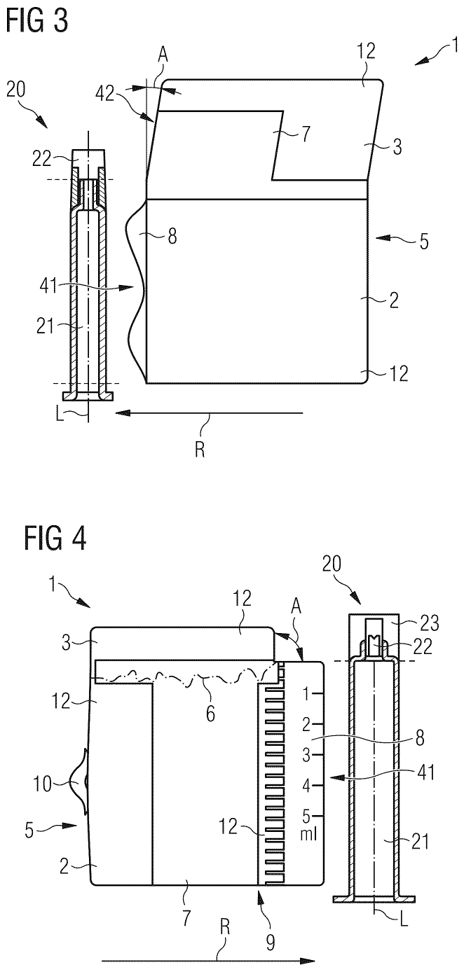

The first label edge 4 essentially has two sections, one of which forms a front edge 41 of the first label portion 2 and the other of which forms a front edge 42 of the second label portion 3. The front edges 41, 42 can be straight or curved and/or follow a predetermined contour (see also FIGS. 3, 5, 7, and 8). With respect to the application direction R, they form, at least in sections, a foremost position of the respective label portion 2, 3 at the front label edge 4. The two front edges 41, 42 of the two label portions 2 and 3 are arranged such that a predetermined residue of the second label portion 3 is arranged with respect to the application direction R. This can be achieved in particular by the two front edges 41, 42 of the two label portions 2 and 3 being inclined relative to each other and an angle A between a continuing projection of the front edge 41 of the first label portion 2 and the front edge 42 of the second label portion 3 being predetermined.

According to FIG. 1, the front label edge 4 in the area of the first label portion 2 is aligned essentially parallel to a longitudinal axis L of the syringe 20. The first label portion 2 is attached to a surface of the syringe 20 and wrapped around it. The syringe 20 is usually cylindrical and essentially rotationally symmetrical with respect to the longitudinal axis L. Alternatively, the syringe 20 may also have a different shape. For example, the syringe 20 may be designed with a slightly conical outer shape, with the area with the smaller diameter facing the side of the syringe needle. The front edge 42 of the second label portion 3 is inclined at a predetermined angle to the front edge 41 in the area of the first label portion 2 or to the longitudinal axis L, so that during an application process it contacts the syringe 20 or the syringe cap 22 subsequent to the front edge 41. 23 during the application process.

According to the embodiment shown in FIG. 1, the label 1 also has an adhesive area 12 and a non-adhesive area 7. For example, the label 1 is designed as a self-adhesive film element and/or has an adhesive layer on its underside so that the label 1 can be easily and reliably adhered to the syringe 20. The non-adhesive area 7 can be implemented by not applying any adhesive to the underside in this area and/or by applying an adhesive weakening agent which weakens the adhesive effect to a predetermined extent. According to FIG. 1, the adhesive-neutral area 7 is designed to match the position and geometry of the syringe cap 22, 23, so that no adhesive contact is established between the syringe cap 22, 23 and the label 1 when wrapping. Above and below the adhesive-neutral area 7, an adhesive connection to the tip 20 and/or the label 1 is established within itself.

Label 1 can cover a section of syringe 20 or is preferably designed as a wrap-around or over-wrap label and overlaps itself at least partially. According to FIG. 1, syringe cap 22, 23 can be wrapped by the non-adhesive area 7, and label 1 then adheres to itself. Contamination of the syringe cap 22, 23 with adhesive can thus be avoided. The label 1 then surrounds the syringe cap 22, 23 like a sleeve and is adhered to itself, closed, and sealed in an area above the syringe cap 22, 23. This allows a useful hermetic enclosure of the syringe cap 22, 23 to be created.

It is also advantageous if the adhesive-neutral area is provided in a transition area between the first and second label portions 2 and 3, which, when applied, is associated with the transition between the syringe cap 22, 23 and the syringe body 21. This improves the opening dynamics of the labeled syringe 20, since less force is required to unscrew and/or pull off the syringe cap 22, 23 and cut through the label 1 compared to a label that adheres over the entire surface. Alternatively or additionally, the label 1 may have a cutting element in the form of a tear strip and/or a perforation 6 in such a cutting area, which enables the label 1 to be torn easily and in a predetermined manner (see also FIGS. 4-9). The perforation 6 also allows the label 1 to be cut through by a twisting and/or pulling motion, revealing any underlying layers that may contain colored opening indicators and/or other information.

According to a further embodiment, the label 1 has a protruding area 8 at the front edge 4 of the first label portion 2. The protruding area 8 can facilitate easier application of the label 1 during automated dispensing onto syringes 20. The protruding area 8 may be siliconized on the upper side so that the label 1 can be detached from itself again in this area if necessary, for example to view printed information and/or to enable a content check of the syringe 20. The protruding area 8 and the front edge 41 of the first label portion 2 bordering it can be straight and/or curved and/or designed with an otherwise predetermined contour (see also FIGS. 3-5). A superficially siliconized area may cover the protruding area 8 or may also extend significantly beyond it. The siliconized area is positioned in particular so that, in relation to the circumference of the container as the primary packaging material, the layer above it can be opened more easily in the desired area.

FIG. 4 shows another embodiment of the label 1, which has a graduation in the protruding area 8 that can be useful for checking the contents of the syringe 20. Preferably, the protruding area 8 is then siliconized on the upper side so that the label 1 can be unwound from it for visual inspection. The length, height, width, and/or thickness of the label 1 are designed to match the geometry of the syringe 20 or the syringe body 21 and/or the syringe cap 22 and/or 23 to which the label 1 is to be attached.

According to FIG. 4, three separate adhesive areas 12 are therefore provided, which are separated from each other by the T-shaped non-adhesive area 7. Accordingly, there are one or more transition areas 9 between one or more adhesive-neutral and adhesive areas 7 and 12. When the syringe 20 is wrapped with the label 1, the upper adhesive area 12 is adhesively connected to the syringe cap 22, 23. The protruding adhesive area 12 is first adhesively bonded to the syringe body 21. The subsequent adhesive area 12 comes to rest on the upper side of the protruding area 8 and covers the graduation. Furthermore, the label 1 may have a grip tab 10 on the rear label edge 5, which is preferably adhesive-neutral or has reduced adhesive strength on the underside so that it can be handled and lifted more easily. The angle A at the front label edge 4 between the two label portions 2 and 3 can, for example, be formed at substantially 90° (see also FIG. 9).

FIG. 5 shows another embodiment of label 1, which, compared to the embodiment shown in FIG. 4, has an angle A greater than 90° at the front label edge 4 between the two label portions 2 and 3 (see also FIG. 6). In addition, the front edge 41 of the first label portion 2 is partially curved.

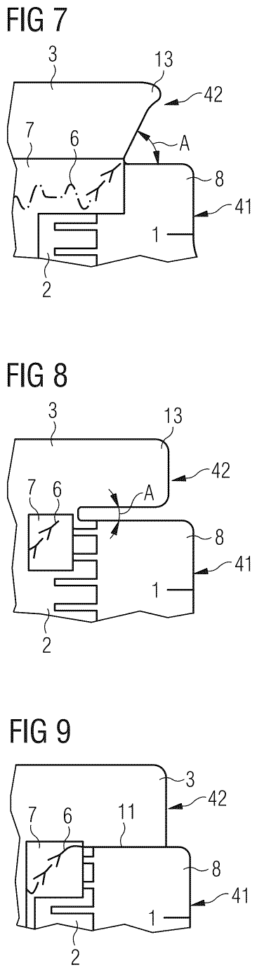

FIGS. 6-9 show enlarged sections of the front label edge 4 in the area of the transition between the two label portions 2 and 3 in respective detailed views. The transition can be determined, for example, by the perforation 6. FIG. 7 shows an embodiment of the label 1 in which the angle A at the front label edge 4 between the two label portions 2 and 3 is less than 90°. The second label portion 3 has a protruding area 13, which, however, is still set back in comparison to the protruding area 8 of the first label portion 2, so that the first label portion 2 always comes into contact with the syringe body 21 or the syringe 20 before the second label portion 3 when applied as intended. The front edge 42 of the second label portion 3 can thus be formed to extend vertically (see FIGS. 4 and 8-9), obliquely forward (see FIG. 7) or obliquely backward (see FIGS. 1-3 and 5-6).

FIG. 8 shows another embodiment of the label 1 and illustrates that the angle A at the front label edge 4 between the two label portions 2 and 3 can also be 180°. Alternatively, the angle A in FIG. 8 can be related to the adjacent edges formed adjacent to the perforation 6, so that in this area the angle A can be designated as 90°. In each case, the label 1 according to FIG. 8 has a protruding area 8 and 13 of the first and second label portions 2, 3, respectively, between which a predetermined free space is formed. Such a free space can, for example, provide a recess for elements of the syringe 20 that extend radially outward and would make labeling with a full-surface label difficult.

FIG. 9 shows a further embodiment of the label 1, in which the two label portions 2, 3 adjoin each other at their front edges 41, 42 and are separated from each other in sections by a slit 11. The slit 11 extends, for example, up to the perforation 6 in the adhesive-neutral area 7 and provides a certain degree of mobility of the two label portions 2, 3 relative to each other in the area of the front edges 41, 42. This can have a beneficial effect on the labeling process when the label 1 is applied to the syringe 20. Alternatively, the slit 11 can also be longer or shorter and/or have a predetermined course that is not straight throughout.

The label 1 can be applied to the syringe 20 as follows, according to the flow chart in FIG. 10:

In step S1, the syringe 20 is provided as a multi-part container. In the same step S1 or in a further step S2, a design for the label 1 is provided.

In step S3, the label 1 is attached to the syringe 20, whereby the syringe 20 is wrapped with the label 1. In the process, the first label portion 2 is brought into contact with the syringe body 21 and adhesively attached thereto. Subsequently, the second label portion 3 is brought into contact with the syringe cap 22, 23 and adhesively attached to and/or around it.

The label 1 is thus applied to the syringe 20 without allowing any undesirable forces to act on the syringe cap 22, 23 and without compromising the sterility of the syringe 20. When the labeled syringe 20 is opened, the label 1 can be cut through as specified and at least part of the second label portion 3 can be removed together with the syringe cap 22 and/or 23 from the first label portion 2 and the syringe body 21.

Label 1 can be fixed to the syringe body 21 thanks to the specially designed leading edge 4 of the label, before the trailing part of label 1 covers the syringe cap 22, 23. The label structure makes it possible to avoid or minimize the transfer of mechanical forces to the syringe cap 22, 23 during labeling. This prevents torsional movements between the components of the syringe 20 and the label 1, which could adversely affect the sterility of the syringe 1 and the labeling process. Due to the label structure described, it is possible, for example, to dispense a large number of such labels 1 at high speed by machine, whereby, for example, 300-400 syringes per minute can be labeled reliably and safely without compromising their sterility. Furthermore, the syringes 20 can be reliably sealed and protected against tampering by means of a respective label 1. The label 1 provides a secure tamper-evident feature and can clearly indicate unauthorized openings.

Depending on the geometry of the syringe 20 or another container to which the label 1 is to be attached, the label 1 may have a grip tab 10 and/or special geometries, such as rectangular or jagged recesses. Furthermore, an adhesive of the label 1 may be neutralized in certain areas in order to form the adhesive-neutral area 7 in a predetermined manner. The label 1 can be made of a UV protective film and/or a barrier film that provides a barrier against oxygen and/or water vapor. Alternatively or additionally, the label 1 can be coated with black paint on its underside facing the syringe 20 in order to prevent or minimize light reflections and light effects. In addition, the label 1 may have an RFID function in the area of the syringe body 21 and/or in the area of the syringe cap 22, 23, which can be combined with a so-called “tamper loop function” that is useful in a transition area between the syringe body 21 and the syringe cap 22, 23. Furthermore, the label 1 may additionally or alternatively have an inspection window or be designed to be partially or completely transparent.

FIG. 11 shows another possible design of the label 1, in which the first and second label portions 2, 3 are not offset from each other. The label 1 thus has an essentially square or rectangular shape or overall contour, so that the first label portion 2 does not protrude beyond the second label portion 3 and does not have a leading front edge 41 or a trailing front edge 42 in the area of the second label portion 3. The front edges 41, 42 are, for example, formed in a straight line along a common straight line. The other features of the label 1 described above in connection with FIGS. 1 to 10 can also be provided for this design of the label 1. In particular, the label 1 may have functions such as a scale, a tab 10, RFID functionality, a perforation 6, a UV protective film, and/or a barrier film.

### LIST OF REFERENCE SIGNS

1 label
2 first label portion
3 second label portion
4 front label edge
41 front edge of the first label portion
42 front edge of the second label portion
5 rear label edge
6 perforation
7 non-adhesive area
8 protruding area of the first label portion
9 transition area
10 grip tab
11 slit
12 adhesive area
13 protruding area of the second label portion
20 container/syringe
21 container body/syringe body
22 closure element
23 cap element
A angle between leading and trailing label portions
L longitudinal axis of the container/syringe
R direction of label application
S(i) steps of a method for applying a label to a container

1. A label (1) for a multi-part container (20), comprising:
a front label edge (4) and an opposite rear label edge (5), and
a first label portion (2) and an adjacent second label portion (3) extending along the front and rear label edges (4, 5), respectively, wherein the first label portion (2) is adapted to be attached to a container body (21) of the container (20), and the second label portion (3) is designed to be attached to a container closure (22, 23) of the container (20), wherein the first label portion (2) protrudes relative to an application direction (R) at the front label edge (4) relative to the second label portion (3) so that, when the label (1) is applied to the container (20) in the normal manner, the first label portion (2) comes into contact with the container (20) before the second label portion (3) as specified, and so that when the container (20) to which the label (1) is applied is opened, the label (1) can be cut through and at least part of the second label portion (3) can be removed from the first label portion (2) and the container body (21) together with the container closure (22, 23).

2. The label (1) according to claim 1, wherein the first label portion (2) and/or the second label portion (3) has an adhesive area (12) and an adhesive-neutral area (7) on a respective underside, so that the first and/or the second label portion (2, 3) can be adhesively attached to the container (20) at least in sections.

3. The label (1) according to claim 1, wherein the first label portion (2) has a siliconized area on the front label edge (4) on an upper side, so that a predetermined weakening of the adhesive is provided.

4. The label (1) according to claim 1, wherein the first label portion (2) is formed with a wave shape or crenellated shape at the front label edge (4).

5. The label (1) according to claim 1, wherein the first label portion (2) has a protruding area (8) at the front label edge (4), which comprises a graduation for a filling volume for a content of the container (20).

6. The label (1) according to claim 1, wherein the front label edge (4) is designed such that an angle (A) with a value greater than 0° up to and including 180° is provided in a transition between the first and second label portions (2, 3).

7. The label (1) according to claim 6, wherein the second label portion (3) has a protruding area (13) at the front label edge (4) which is spaced apart from the first label portion (2) so that an angle (A) with a value of 180° is essentially formed in the transition between the first and second label portions (2, 3) at the front label edge (4).

8. The label (1) according to claim 1, wherein a slit (11) is formed in a transition between the first and second label portions (2, 3) so that the first and second label portions (2, 3) are separated in sections at the front label edge (4).

9. The label (1) according to claim 1, wherein the first label portion (2) and/or the second label portion (3) comprises a respective label layer which provides a barrier function against the passage of a gas and/or a liquid, a protective function against UV radiation and/or a predetermined temperature resistance.

10. The label (1) according to claim 1, wherein the first label portion (2) and/or the second label portion (3) comprises a respective label layer which is formed as an at least partially transparent, white and/or colored film element.

11. The label (1) according to claim 1, wherein the first label portion (2) and/or the second label portion (3) has an adhesive area (12) with a black adhesive and/or a black reference layer on a respective underside.

12. The label (1) according to claim 1, comprising:
an adhesive-neutral tear-off area with a perforation (6) which is formed between the first and second label portions (2, 3) so that when the container (20) to which the label (1) is applied is opened, the label (1) can be severed along the perforation (6) in a predetermined manner and at least part of the second label portion (3) can be removed together with the container closure (22, 23) can be removed from the first label portion (2) and the container body (21).

13. The label (1) according to claim 1, wherein the second label portion (3) is designed in coordination with the container (20) such that, when the label (1) is applied to the container (20), the second label portion (3) is closed in on itself above the container closure (22, 23) in relation to a longitudinal axis (L) of the container (20).

14. The label (1) according to claim 1, comprising:
an RFID transponder with an RFID chip and an antenna structure that is signal-coupled to the RFID chip.

15. A system comprising:
a container (20) that can be divided into several parts, with a container body (21) and a container closure (22, 23) that is coupled to the container body (21), and
the label (1) according to claim 1, which is applied to the container (20) in such a way that the first label portion (2) of the label (1) is attached to the container body (21) and the second label portion (3) of the label (1) is attached to the container closure (22, 23).

16. A method for applying a label (1) to a multi-part container (20) according to claim 1, comprising:
providing a container (20) that can be divided into several parts, with a container body (21) and a container closure (22, 23) that is coupled to the container body (21), and
attaching the label (1) to the container (20) so that the first label portion (2) comes into contact with the container (20) and is attached to the container body (21), and subsequently the second label portion (3) comes into contact with the container (20) and is attached to the container closure (22, 23) so that when the container (20) with the label (1) applied is opened, the label (1) can be severed in a predetermined manner and at least part of the second label portion (3) together with the container closure (22, 23) can be removed from the first label portion (2) and the container body (21).
